(19) United States
(12) Patent Application Publication
(10) Pub. No.: US 2016/0279566 A1
(43) Pub. Date: Sep. 29, 2016

(54) PROCESS FOR REMOVING MERCAPTANS FROM A GAS STREAM

(71) Applicant: SHELL OIL COMPANY, Houston, TX (US)

(72) Inventors: Jozef Jacobus Titus SMITS, Amsterdam (NL); Sipke Hidde WADMAN, Amsterdam (NL)

(21) Appl. No.: 15/036,130

(22) PCT Filed: Nov. 10, 2014
(86) PCT No.: PCT/EP2014/074196

§ 371 Date: May 12, 2016

(30) Foreign Application Priority Data
Nov. 14, 2013 (EP) 13192909.3

(51) Int. Cl. B01D 53/78; B01D 53/18; B01D 53/48; B01D 53/14

(52) U.S. Cl. CPC B01D 53/78; B01D 53/1425; B01D 53/1487; B01D 53/18; B01D 53/48; B01D 2257/306

(57) ABSTRACT

The present invention relates to a process for removing mercaptans from a gas stream. First, a gas stream comprising at least a mercaptan of the general formula R₁—SH, wherein R₁ is an alkyl group comprising 1 to 4 carbon atoms, may be contacted with an absorption medium comprising a solvent, a substituted disulfide of the general formula R₂—SS—R₃ wherein R₂ and R₃ are carbon comprising substituents of which the corresponding R₂—SH and R₃—SH thiols have a vapour pressure below the vapour pressure of any R₁—SH thiol and at least one of R₂ and R₃ is an electron withdrawing group; and at least a catalytic amount of a base. The absorption medium may be retrieved and regenerated in a regeneration unit. The regenerated absorption solution may be recycled and subjected to oxidation.

### FIELD OF THE INVENTION

The invention relates to a process and system for removing mercaptans from a gas stream.

### BACKGROUND OF THE INVENTION

Natural gas comprises mainly methane and can further comprise other components such as higher hydrocarbons (e.g. ethane, propane, butanes, pentanes). In addition, it may also comprise significant amounts of undesired sulphur contaminants and carbon dioxide. Common sulphur contaminants are hydrogen sulfide (H₂S), mercaptans (RSH, also referred to as thiols), and carbonyl sulfide (COS).

In GB 1551344, a process is described using (non-aqueous) liquid organic disulfide mixtures as a solvent to absorb contaminating gaseous sulphur compounds from gas streams, e.g. hydrogen sulfide and sulphur dioxide.

Further processes for removing hydrogen sulfide, COS and carbon dioxide are known which use an amine-containing absorption liquid based on a chemical absorbent, also referred to as selective amine absorption process. In such a process, a gas stream comprising hydrogen sulfide, COS and carbon dioxide is contacted with the amine-containing absorption liquid in an absorption unit, also referred to as amine treating unit. The hydrogen sulfide, COS and/or carbon dioxide are selectively absorbed (by a chemical, acid-base, interaction with the amine mix) in the amine-containing absorption liquid and thereby removed from the gas stream. However, a disadvantage of such a process is that it does not provide an efficient absorption of mercaptans. Mercaptans, having a much higher pKa than e.g H₂S, do not show chemical interaction with the amine mix to such an extent that they can be effectively removed in that process. Mercaptans are only partly removed by physical interaction with the absorbent (solution/dissolution process).

In a recently developed process mercaptan contaminants may be removed from a gas stream through a reversible chemical reaction by contacting the mercaptan-comprising natural gas stream with an absorption medium comprising a specific substituted organic disulfide in combination with at least catalytic amounts of a base (see WO2012076378 and WO2012076502). Said process is selective for mercaptans, without absorbing condensate/gas. The processes of WO2012076378 and WO2012076502 are based on chemical interaction of mercaptans with the organic disulfide rather than by physical interaction with the absorption medium (i.e. solubility). Mercaptans in the gas stream react with said disulfides to reversibly form “new” mixed disulfide products and a “new” thiol (e.g. MeSH+RSSR<=>MeSSR+RSH). As that reaction is an equilibrium reaction, regeneration into the original disulfides is achieved by removal of the mercaptan (MeSH in the example given above) from the absorption medium, preferably using a strip gas at elevated temperatures. However, it has now been found that the reverse reaction to regenerate the original disulfides is slower than expected. It was further found that this results in build-up of amounts of the “new” thiol in the regenerated absorption medium and undesired consumption of the organic disulfide during the mercaptan removal process.

### SUMMARY OF THE INVENTION

A new optimized process has now been developed to solve the problems of build-up of the “new” thiol and the undesired disulfide consumption.

Accordingly, the present invention relates to a process for removing mercaptans from a gas stream, comprising the steps:
(a) contacting a gas stream comprising at least a mercaptan of the general formula R₁—SH, wherein R₁ is an alkyl group comprising 1 to 4 carbon atoms, with an absorption medium comprising (1), (2) and (3):
   (1) a solvent;
   (2) a substituted disulfide of the general formula R₂—SS—R₃ wherein R₂ and R₃ are carbon comprising substituents of which the corresponding R₂—SH and R₃—SH thiols have a vapour pressure below the vapour pressure of any R₁—SH thiol and at least one of R₂ and R₃ is an electron withdrawing group; and
   (3) at least a catalytic amount of a, preferably nitrogen-containing, base, the catalytic amount being at least 3 mol % with regard to the amount of the substituted disulfide;
   wherein the absorption medium is an aqueous solution comprising the substituted disulfide and the, preferably, nitrogen-containing base;
(b) retrieving the absorption medium after use in step (a);
(c) regenerating the absorption medium (i.e. removing the “chemically absorbed” mercaptans from the absorption medium) in a regeneration unit;
(d) recycling the regenerated absorption solution to step (a);
wherein the process further comprises a step (c)′, which follows step (c) and precedes step (d), in which at least a part of the regenerated absorption medium is subjected to oxidation.

In the oxidation step, the built-up “new” thiols are oxidized into the original disulfides, which can be re-used in the process. Thus, the problems of build-up of thiols and consumption of the disulfides are solved. The process of the invention provides an optimized process for removing mercaptans from a gas stream allowing efficient re-use of substituted disulfides.

### DETAILED DESCRIPTION OF THE INVENTION

In the process according to the present invention mercaptans are removed from a mercaptan-comprising gas stream.

Reference herein to mercaptans (R₁—SH) is to aliphatic mercaptans. The invention especially involves removal of methyl mercaptan (R₁=methyl), ethyl mercaptan (R₁=ethyl), normal- and iso-propyl mercaptan (R₁=n-propyl and i-propyl) and butyl mercaptan (R₁=butyl) isomers. These mercaptans have vapour pressures in the range of from 5 to 210 kPa measured at 25° C. Reference herein to the vapour pressure of a thiol (or mercaptan) is to the vapour pressure as measured at 25° C. according to ASTM E1194 for thiols having a vapour pressure in the range of from 1×10⁻¹¹ to 1 kPa and ASTM 2879 for thiols having a vapour pressure above 1 kPa, wherein in case of doubt the vapour pressure according to the method of ASTM E1194 takes precedents. In case a thiol has a vapour pressure below 1×10⁻¹¹ kPa, the vapour pressure of the thiol is for the purposes of the invention considered to be zero.

It is believed that the R₁SH mercaptan in the process of the invention reversibly reacts with the substituted disulfide (2) in the absorption medium. During this reaction with the substituted disulfide, a R₂—SH and/or R₃—SH thiol is/are formed together with a R₂—SS—R₁ and /or R₁—SS—R₃ disulfide, and subsequently amounts of R₁—SS—R₁ may be formed. Due to the higher vapour pressure of the formed thiols, the process conditions under which mercaptan-comprising gas stream is contacted with an absorption medium can be chosen such that most of or essentially all of the formed thiols remain captured in the absorption medium together with the newly formed substituted disulfides, which generally have low vapour pressures.

Preferably, R₂ and R₃ are carbon comprising substituents of which the corresponding R₂—SH and/or R₃—SH thiols have a vapour pressure below 1 kPa, more preferably below 0.5 kPa, even more preferably 0.01 kPa, still even more preferably 0.001kPa as determined as defined herein above.

R₂ and R₃ may be the same or different. In case, R₂ and R₃ are the same, the variety of thiols formed is reduced, making the selection of the operation conditions and optional regeneration conditions easier. In case R₂ and R₃ are different, one of them is an electron withdrawing group and the other may be another electron withdrawing group or another suitable group as further defined herein.

Preferably, R₂ and R₃ are chosen such that the corresponding R₂—SH and/or R₃—SH thiols are liquid or dissolved in the absorption medium at the temperature and pressure conditions at which the mercaptan-comprising gas stream is contacted with the absorption medium.

According to the invention, at least one of R₂ and R₃ is an electron withdrawing group. Such substituents result in disulfides with a higher tendency to react with the R₁—SH mercaptan.

Electron withdrawing groups are well known in the art, and are for example selected from substituted alkyl comprising at least 5 carbon atoms, preferably comprising at least 7 carbon atoms, more preferably at least 10; optionally substituted aryl comprising 6 to 14 carbon atoms (such as phenyl, naphthyl, tolyl, and the like); and optionally substituted heteroaryl group comprising 5 to 13 carbon atoms (such as pyrolyl, thiophenyl, furanyl and pyridinyl); wherein each of the substituents may be selected from one or more —OH, —SH, halogen (preferably fluoro), carboxylic acid, carboxylate, amino (for example —NH₂, —NH(alkyl), —N(alkyl)₂, wherein the alkyl group comprises 1 to 6 carbon atoms and may be substituted with —OH), nitro, ether and thioether (such as —O—((C1-C4)alkyl), oligoether, polyether, —S—((C1-C4)alkyl), oligothioether, polythioether, and the like), ester (such as —O—C(O)—((C1-C4)alkyl), —C(O)—O—((C1-C4)alkyl), and the like), sulfonic acid, sulfonyl (such as ((C1-C4)alkyl)sulfonyl, tosylsulfonyl and the like), sulfonate groups (such as ((C1-C4)alkyl)sulfonate, triflate, tosylate and besylate), and the like.

Alkyl groups as mentioned herein may be branched or unbrached alkyl groups. The term (C1-C4)alkyl refers to an alkyl group with 1 to 4 carbon atoms.

Further suitable R₂ and R₃ groups include:
alkyl groups comprising at least 5 carbon atoms, preferably comprising at least 7 carbon atoms, more preferably at least 10;
alkenyl groups comprising at least 5 carbon atoms, preferably comprising at least 7 carbon atoms, more preferably at least 10;
alkynyl groups comprising at least 5 carbon atoms, preferably comprising at least 7 carbon atoms, more preferably at least 10;
cycloalkyl groups comprising at least 5 carbon atoms;
alkoxy groups, including ketones, aldehydes, (poly)ethers, (poly)esters, carboxylic acid and carboxylate groups;
amine and amino groups;
polymers;
   wherein the alkyl group is defined as mentioned herein before.

Suitable R₂ and R₃ substituents further include substituents comprising a combination of any of the functional groups mentioned herein above, for example a combined aryl and alkanol group such as a phenolic substituent group. In case an alkyl, alkenyl or alkynyl is combined with another functional group to form a substituent any number of carbon atoms may be used such as for instance an ethylphenylic substituent group.

Reference herein to aryl groups is to comprising one or more aromatic ring structures, including naphthenic and polycyclic ring structures, for example 2,2′-dithiobisbenzothiazole.

Reference herein to substituted aryl groups is to aryl groups comprising one or more phenyl rings, wherein the aryl group further comprises at least one other functional group, for example benzoic acid.

In a preferred embodiment, R₂ and R₃ comprise both electron withdrawing groups as well as further functional groups that improve solubility in the absorption medium. In case of an aqueous absorption medium or polar organic absorption medium, the further functional groups are preferably hydrophilic functional groups, more preferably those that can form hydrogen bonds. Examples of hydrophilic functional groups include alcohols, acids, carboxylates, amines, sulphuric and sulphurous groups. In case of a non-polar organic absorption medium, the further functional groups are preferably hydrophobic functional groups. Examples of hydrophobic functional groups include aryl, alkyl, alkenyl and alkynyl groups.

Preferably, the R₂—SS—R₃ substituted disulfide is soluble in the absorption medium, being an aqueous or organic absorption medium, in the presence of the nitrogen-containing base. More preferably, the products obtained upon contact with the R₁SH mercaptan, R₂—SS—R₁ and/or R₁—SS—R₃, are also soluble in the absorption medium in the presence of the nitrogen-containing base. More preferably, the further products obtained upon contact with the R₁SH mercaptan, R₂—SH and R₃—SH, are also soluble in the absorption medium in the presence of the nitrogen-containing base.

Preferred substituted disulfides include, but are not limited to: diphenyl disulfide, ditoluyl disulfide, di-nitrophenyl disulfide, dithiodibenzoic acid, di-(oligoethyleneglycol-phenyl) disulfide, dinaphtyl disulfide, dipyridyl disulfide, 2,2′-dithiobisbenzo-thiazole.

Particularly preferred substituted disulfides, as they dissolve well in the absorption medium of the present invention, include, but are not limited to: dithiodibenzoic acid, dithiodi(potassium benzoate) and di-(oligoethyleneglycol-phenyl) disulfide.

In a further embodiment, at least one of substituents R₂ and R₃ is a polymer. Polymeric thiols have very low to almost no vapour pressure. The polymer-based disulfide may be provided as a solid absorption medium or as dispersion in a liquid medium.

In a preferred embodiment, at least one of R₂ and R₃ is an alkanol, alkoxy or aryl group, preferably an aryl group, more preferably an substituted aryl group rendering the disulfide water soluble, and most preferably an alkanol-, alkoxy- or carboxylate-substituted arylgroup.

Selection of the most suitable groups R₂ and R₃ depends on the nature of the absorption medium and is, based on the information provided herein above, within the general skills of a person skilled in the art.

In an embodiment of the invention the substituted disulfide (2) is present in the absorption medium in 50 weight % or less, preferably 25 weight % or less, more preferred 10 weight % or less, even more preferred 5 weight % or less, and in particular in the range between 2 to 0.1 weight %.

The absorption medium comprises a, preferably nitrogen-containing, base. Preferably, the base is an amine-containing base.

The base catalyses the reaction between the substituted disulfide and the R₁SH mercaptan. In the absence of a base the reaction proceeds hardly notable. Therefore, according to the present invention, at least a catalytic amount of the base must be present in the absorption medium, wherein the term “catalytic” refers to the action of the base to significantly accelerate (meaning an acceleration of rate of reaction with a factor of more than 10, preferably more than 100) the reaction between the R₁SH mercaptan and the substituted disulfide. To such extent, an amount of at least 3 mol %, preferably at least 5 mol % of the base should be present with regard to the amount of the substituted disulfide.

In addition, the base may reversibly react with acid components in the mercaptan-comprising gas stream, such as any hydrogen sulfide, carbon dioxide and/or COS in the mercaptan-comprising gas stream. Therefore, sufficient base must be added to ensure that at relevant stages in the process a catalytic amount of unreacted or free base is present in the absorption medium. The required concentration of the base can be determined based on the expected amount of base that will be necessary to reversible bond with any acid components in the gas stream. Based on the acid component content of the mercaptan-comprising gas stream and the volume of mercaptan-comprising gas stream contacted per unit absorption medium, the minimum amount of base required can be easily determined.

As mentioned herein above the base may react with the acid components in the mercaptan-comprising gas stream. Depending on the strength of the base this reaction may be reversible or irreversible. Generally two types of base can be identified:
strong bases, i.e. bases having a pKa of 14 or higher; and
weak bases, i.e. having a pKa below 14

Generally, the reaction of strong bases such as NaOH, KOH, Ca(OH)₂ and Ba(OH)₂ is irreversible, whereas reactions with weaker bases, such as NEt₃, alanine, ammonia, methylamine, diethanolamine, methyldiethanol-amine, sodium acetate, sodium carbonate or pyridine are generally reversible.

Preferred bases are weak bases as these do not lead to irreversible reaction with any to the acid components in the mercaptan-comprising gas. Preferably the base has a pKa below 14, more preferably a pKa below 11.

Reference herein to the pKa of a base is to the pKa as determined by ASTM D1067-06.

According to the present invention, the absorption medium is an aqueous solution comprising the substituted disulfide and the (preferably nitrogen-containing) base dissolved therein. Hence the solvent comprises water.

A preferred absorption medium is an aqueous amine-comprising absorption liquid. Particularly suitable aqueous amine-comprising absorption liquids are those that are generally used for removing so-called acid gases such as hydrogen sulfide, carbon dioxide and/or COS from a gas stream containing these compounds. These aqueous amine-containing absorption liquids have been extensively described in the art. See for instance A. L. Kohl and F. C. Riesenfeld, 1974, Gas Purification, 2nd edition, Gulf Publishing Co. Houston and R. N. Maddox, 1974, Gas and Liquid Sweetening, Campbell Petroleum Series. On an industrial scale, such absorption liquids are in principal classified in two categories, depending on the mechanism to absorb the acidic components: chemical absorbents and physical absorbents. Reference herein to a chemical absorbent is to a liquid that absorbs an acid gas by a reversible chemical reaction (acid-base). Reference herein to a physical absorbent is to a liquid that absorbs an acid gas by a physical solution/dissolution process. Examples of physical absorbents include cyclo-tetramethylenesulfone and its derivatives, aliphatic acid amides, N-methylpyrrolidone, N-alkylated pyrrolidones and the corresponding piperidones, methanol, ethanol and mixtures of dialkylethers of polyethylene glycols or mixtures thereof. Physical absorbents are generally used in combination with chemical absorbents. Such combinations are referred to as mixed absorbents. Each absorbent has its own advantages and disadvantages with respect to features as loading capacity, kinetics, regenerability, selectivity, stability, corrosivity, heating/cooling requirements etc.

In the process according to the present invention chemical absorbent-based absorption liquids are preferred as they do not significantly absorb condensate components in the mercaptan-comprising gas stream. Reference herein to condensates is to C2⁺ hydrocarbons including BTX (benzene, toluene and xylene) components. Physical absorbents do absorb condensate components, thereby undesirably removing these valuable condensate components from the gas stream. According to the present invention, reference to chemical absorbent-based absorption liquids is to absorption liquid that rely on a reversible chemical acid-base reaction to absorb an acid gas in the absence of significant amounts of physical absorbents.

The chemical absorbents, which are useful in the process of the present invention, preferably, comprise an aliphatic alkanolamine and a primary or secondary amine as activator, the action of which accelerates the rate of CO₂ absorption. The chemical absorbent further comprises water or another suitable solvent. Preferred aliphatic alkanolamines include monoethanolamine (MEA), di-isoproponalamine (DIPONA) and tertiary alkanolamines, especially triethanolamine (TEA) and/or methyldiethanol-amine (MDEA). Suitable activators include primary or secondary amines, especially those selected from the group of piperazine, methylpiperazine and morpholine. Preferably, the chemical absorbent comprises in the range of from 1.0 to 5 mol/l, more preferably from 2.0 to 4.0 mol/l of aliphatic alkanolamine. Preferably, the chemical absorbent comprises in the range of from 0.5-2.0 mol/l, more preferably from 0.5 to 1.5 mol/l of the primary or secondary amine as activator. Especially preferred is a chemical absorbent comprising MDEA and piperazine. Most preferred is a chemical absorbent comprising in the range of from 2.0 to 4.0 mol/l MDEA and from 0.8 to 1.1 mol/l piperazine. These chemical absorbent-based absorption liquids contain a nitrogen-containing base and have the additional advantage that they efficiently remove carbon dioxide, COS and hydrogen sulfide from the mercaptan-comprising gas stream, if present, in particular at high pressures.

By adding, according to the present invention, a substituted disulfide to, and preferably dissolving it in, an amine-containing absorption liquid, an absorption medium comprising the substituted disulfide and a nitrogen-containing base according to the present invention is obtained whereby the amine-containing absorption liquid provides both the absorption medium and the nitrogen-containing base.

In an embodiment of the invention, the mercaptan removal process according to the invention is preceded by a conventional amine-based separation process step for removing acid components such as hydrogen sulfide, carbon dioxide and COS from a gas stream comprising such components. By pre-treating the mercaptan-comprising gas stream with an amine-based separation process, the acid component content of the mercaptan-comprising gas stream is lowered if not removed in total, thereby reducing the amount of base required in the absorption medium.

Reference herein to an amine-based separation process is to a process comprising an amine-containing absorption liquid. The amine based separation process is typically performed in an amine treating unit. Such amine treating units are well known for extracting hydrogen sulfide and/or carbon dioxide from gas stream. These amine treating units generally are based on a contactor (also referred to as absorber) for contacting a gaseous stream with a liquid absorbent. The amine based separation process is based on a washing process wherein a gas stream is washed with a chemical absorbent, in particular an aqueous amine solution. The gas stream is separated by chemical adsorption of certain components. i.e. hydrogen sulfide and carbon dioxide, in the gas stream (solvent extraction).

As mentioned herein above, during step (a) of the process R₁—SH mercaptans are removed from the mercaptan-comprising gas stream. In that process step, the absorption medium is being loaded with the reaction products of the reaction between the R₁—SH mercaptans and the R₂—SS—R₃.

The loaded absorption medium is regenerated in step (c) and recycled back in step (d) of the process, while the desorbed R₁—SH mercaptans, and optionally hydrogen sulfide, carbon dioxide and COS, are retrieved separately.

The loaded absorption medium may be regenerated e.g. by stripping the loaded absorption medium with a gas, such as nitrogen or steam.

Preferably, the loaded absorption medium is regenerated by subjecting the absorption medium to an elevated temperature, preferably a temperature in the range of from 80 to 200° C., even more preferably of from 100 to 175° C. By subjecting the loaded absorption medium to an elevated temperature, the desorption process is advantaged and in addition, this allows for an efficient desorption of hydrogen sulfide, carbon dioxide and COS, if these were absorbed from the mercaptan-comprising gas stream.

Preferably, the loaded absorption medium is regenerated by stripping the loaded absorption medium with a gas at elevated temperatures, such as those temperatures mentioned herein above.

In case some of the base is consumed or otherwise lost in the process, it may be preferable to add fresh base to the regenerated absorption medium prior to providing the regenerated absorption medium to step (a).

In addition to the regeneration step, according to the invention the absorption medium is further subjected to an oxidation step (c′). It is not necessary to subject the complete stream of the regenerated absorption medium to oxidation as long as sufficient disulfide is present again in the medium at step (a) of the process. The part of the absorption medium that is subjected to oxidation may be oxidized in a unit separate from the process unit, but in a preferred embodiment step (c)′ is performed as an on-line step, wherein (part of) the regenerated absorption medium is led through an oxidation unit and after passing through that unit is optionally rejoined with the remaining stream of the regenerated absorption medium and further processed in step (d).

For the oxidation any known oxidizing agent may be used that does not interfere with the other components that are present in the absorption medium. Oxidants producing products that are already present in the solution are preferred over those introducing new alien species (e.g. oxygen produces water). In an embodiment of the invention the agent used for oxidation in step (c)′ is selected from H₂O₂, metal oxides, organic peroxides, iodine, amine-N-oxides, nitrogen oxides, sulphur, sulphur dioxide, preferably (a gas containing molecular) oxygen, and most preferably air.

For the oxidation, typical oxidation catalysts may be used, such as metals and metal oxides. Preferred oxidation catalysts are Pd/C and V₂O₅.

The temperature for the oxidation step is suitably selected between the temperature of the regenerator and that of the absorption medium, being preferably from 20° C. up to 175° C., more preferred up to 130° C., in particular up to 100° C.

The pressure for the oxidation step is suitably low, like the pressure in the regenerator, but higher pressures may also be considered.

The process according to the invention may be operated in batch, semi continuous or continuous mode.

Preferably, the process is operated in continuous mode, more preferably by passing the mercaptan-comprising gas stream and separately a stream of absorption medium through a contactor, wherein both streams are continuously contacted. A mercaptan-depleted gas stream is continuously retrieved from the contactor, while simultaneously a stream of loaded absorption medium is retrieved from the contactor. The stream of loaded absorption medium is sent to a regeneration unit to be regenerated, thereafter at least partly oxidized and recycled to the inlet of the contactor. The mercaptan-comprising gas stream and a stream of absorption medium are preferably contacted counter-currently. By contacting the mercaptan-comprising gas stream and the stream counter-currently, the mercaptan-comprising gas stream is contacted with fresh or freshly regenerated absorption medium, comprising the highest amount of base prior to exiting the contactor. This significantly reduces the effect of any acid compounds in the mercaptan-comprising gas stream on the concentration of unbound base in the absorption medium.

The mercaptan-comprising gas stream is preferably contacted with the absorption medium at a temperature in the range of from 0 to 100° C., more preferably of from 10 to 70° C., even more preferably 20 to 60° C. By reducing the temperature the choice of liquid and/or solid absorption media becomes broader.

The mercaptan-comprising gas stream is preferably contacted with the absorption medium under any suitable pressure, preferably a pressure in the range of from 1 to 150 bar absolute, more preferably, 20 to 100 bar absolute, even more preferably 30 to 75 bar absolute.

In case of a continuous process wherein both mercaptan-comprising gas and the absorption medium are continuously contacted, the mercaptan-comprising gas may preferably be supplied to the process at any suitable ratio to the absorption medium. Preferably, the weight ratio of the mercaptan-comprising gas flow (kg_{gas}/h) to the flow of absorption medium (kg_{medium}/h) is in the range of from 0.1 to 100.

The mercaptan-comprising gas stream may be any gas stream comprising mercaptans. Preferably, the mercaptan-comprising gas stream is natural gas. Reference herein to natural gas is to a gas, which generally comprises mainly methane and can further comprise other components such as higher hydrocarbons. The higher hydrocarbons are typically referred to as condensate or condensate components and may include e.g. ethane, propane, butanes, pentanes, benzene, toluene and xylenes. Natural gas may further include components such as nitrogen, carbon dioxide, sulphur contaminants and mercury. The amount and type of sulphur contaminants can vary. Common sulphur contaminants are hydrogen sulfide (H₂S), mercaptans (RSH) and carbonyl sulfide (COS).

It will be appreciated that the composition of the natural gas stream depends on the natural gas field it is extracted from. Typically, the natural gas comprises methane, preferably in the range of from 40 to 99 vol % methane, more preferably 60 to 99 vol % methane, based on the total mercaptan-comprising natural gas stream.

Preferably, the amount of mercaptans in the gas stream supplied to process is in the range of from 1 ppmv to 5 vol %, based on the total mercaptan-comprising gas stream, preferably from 5 ppmv to 5 vol %, more preferably from 6 ppmv to 3 vol %, still more preferably from 10 ppmv to 1500 ppmv.

The mercaptan-comprising gas stream may comprise up to 50 vol % of acid components, based on the total mercaptan-comprising gas stream. Typical acid components include, but are not limited to, hydrogen sulfide, carbon dioxide and or COS.

In an embodiment, the mercaptan-comprising gas stream comprises in the range of from 0 to 5 vol % of acid components, preferably of from 0 to 1 vol %, even more preferably of from 0 to 0.01 vol % acid components, still more preferably of from 0 to 10 ppmV, based on the total mercaptan-comprising gas stream. A lower acid components content is beneficial as less base will be bound by the acid components and thus free for catalysing the process. In such a case, a strong base is preferably selected.

It is further preferred, that the gas stream comprises no or essentially no oxygen (less than 1 ppm).

In a further embodiment, the mercaptan-comprising gas stream comprises at most up to 20 vol % carbon dioxide, based on the total mercaptan-comprising gas stream. Preferably, the mercaptan-comprising gas stream comprises in the range of from 0 to 5 vol % carbon dioxide, preferably of from 0 to 1 vol %, even more preferably of from 0 to 0.01 vol % carbon dioxide, still more preferably of from 0 to 10 ppmV, based on the total mercaptan-comprising gas stream. A lower carbon dioxide content is beneficial as less base will be bound by the carbon dioxide and thus free for catalysing the process.

It is further preferred, that the mercaptan-comprising gas stream comprises at most up to 5000 ppmv of COS, more preferably in the range of from 0 to 5000 ppmv, more preferably of from 0 ppmv to 500 ppmv, even more preferably of from 0 ppmv to 10 ppmv, based on the total mercaptan-comprising gas stream. A lower COS content is beneficial as less base will be bound by the COS and thus free for catalysing the process.

In case the mercaptan-comprising gas stream comprises mercury it is preferred that the mercury is removed prior to the mercaptan removal process.

In another aspect the invention relates to a system for removing mercaptans from a gas stream, the mercaptan being of the general formula R₁—SH, wherein R₁ is an alkyl group comprising 1 to 4 carbon atoms, the system comprising (p) a mercaptan removing unit which comprises an absorption medium comprising: (1) a solvent; (2) a substituted disulfide of the general formula R₂—SS—R₃ wherein R₂ and R₃ are carbon comprising substituents of which the corresponding R₂—SH and R₃—SH thiols have a vapour pressure below the vapour pressure of any R₁—SH thiol and at least one of R₂ and R₃ is an electron withdrawing group; and (3) at least a catalytic amount of a nitrogen-containing base; (q) a regeneration unit, in which the absorption medium after use in a mercaptan removing unit is regenerated; and (r) an oxidation unit, positioned after the regeneration unit. The system may be a system for continuous removal of mercaptan, further comprising a connecting line between the regeneration unit and the mercaptan removing unit, which line optionally comprises a junction by which the exit line coming from the oxidation unit joins, thus allowing to introduce the oxidated part of the regenerated absorption medium. In the latter situation, the oxidation unit (r) is placed in parallel with a line coming from the regeneration unit.

In a preferred embodiment, the effluent (coming) from the regeneration unit, having an elevated temperature, is used in heat exchange contact with the absorption medium retrieved in step (b) to increase its temperature when it is being transferred to the regeneration unit. In that way, at least part of the heat necessary for raising the temperature needed for regeneration is obtained by cooling the effluent stream from step (c).

### BRIEF DESCRIPTION OF FIG. 1

FIG. 1 depicts a conceptual flow scheme for a mercaptan removal system according to the present invention including the oxidation of the free thiol to disulfide. The oxidation unit is placed after the regenerator to prevent oxidation of H₂S (among others). It is also located after the heat exchanger to limit the operation temperature to about 40° C., in which case an atmospheric reactor will suffice. The size of the oxidizing unit is determined by the rate of oxidation. Oxidation needs to be much faster than observed in the tests described in the experimental section, but adequate gas/liquid contact, increased temperature and pressure will accelerate this reaction. As mercaptans are generally only present in low concentration, not the entire stream needs to be passed through this side unit, thus limiting its size.

### LEGENDS TO THE FIGURES

FIG. 1. Concept of mercaptan removal system according to the invention employing disulfides including oxidation of free thiol. Reactions of H₂S and CO₂ with amine solution are not depicted. (NG=natural gas; SRU=sulphur recovery unit)

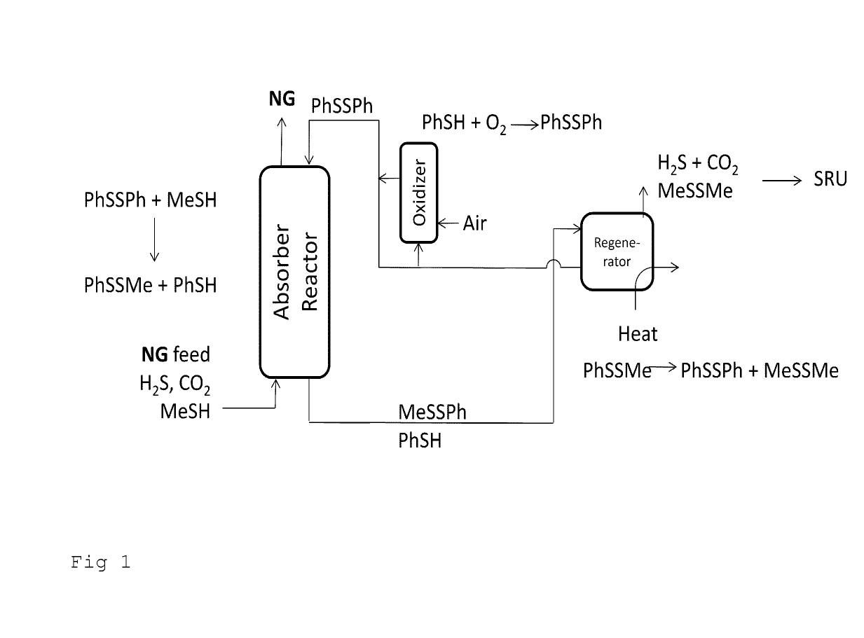

The invention is illustrated by the following non-limiting examples.

### Example 1

Oxidation tests of thiol containing solutions were performed at room temperature and atmospheric pressure. Also a test was performed at 40° C. showing similar results. Air was used as an oxidant, but alternative oxidants could be used as well. Oxidants producing products that are already present in the solution are preferred over those introducing new alien species (e.g. oxygen produces water). The N-oxides of amines are mild oxidants, and the reduced products are water and amine. Thus, trimethylamine-N-oxide was used in a NMR experiment and showed to effectively oxidize free thiol to disulfide (heating a 1:1 mixture of thiol and Me3NO in MDEA:D₂O=1:9 to 70° C. for 1.5 h).

(a) A 50:50 DMEA (dimethylethanolamine):D20 sample containing the thiol KO₂CPhSH (about 50 mg in 0.5 ml solution, i.e. around 10% wt) that was contacted at room temperature and atmospheric pressure with air in the presence of a Pd/C catalyst. The free thiol nicely oxidizes under the formation of the corresponding disulfide. In the absence of the catalyst almost no reaction is observed. See table 1.

(b) A 50:50 MDEA (methyldiethanolamine):D20 sample containing the thiol triethyleneglycolthiophenol (HEO₃PhSH) (about 50 mg in 0.5 ml solution, i.e. around 10% wt) that was contacted at room temperature and atmospheric pressure with air in the presence of a Pd/C catalyst. The free thiol nicely oxidizes under the formation of the corresponding disulfide. In the absence of the catalyst almost no reaction is observed. See table 1.

TABLE 1
Half lifetimes of free “new” thiol.

| thiol | Pd/C | no Cat |
|---|---|---|
| (a) KO₂CPhSH | 1.5 h | >24 h |
| (b) HEO₃PhSH | 1.4 h | >24 h |

### Example 2

In a 25 ml three necked round bottom flask, 4-mercaptobenzoic acid (0.0966 g) was dissolved in 10 ml of D₂O containing 0.228 g NaOD. 0.0337 g of V₂O₅ was added. The mixture was stirred using a magnetic stirrer bean and air was supplied by leaving the round bottom flask open to the air, at room temperature and atmospheric pressure. The free thiol nicely oxidizes under the formation of the corresponding disulfide. The reaction was monitored by NMR. Half life time was determined to be 19 hours.

### Example 3

A 10:90 MDEA (methyldiethanolamine):D₂O sample containing the thiol KO₂CPhSH and the oxidant trimethylamine-N-oxide (1.05 eq) was heated to 70° C. and complete oxidation was observed within an hour.

### Example 4

Regeneration of disulfides with oxygen and Pd/C

In a 100 ml glass reactor 250 mg (˜1% w) of potassium 4,4′-disulfanediyldibenzoate was dissolved in a mixture of 12.5 ml of methyldiethanolamine (MDEA) and 12.5 ml of water. The reactor was closed and the solution flushed with 1 nl/h nitrogen via a dip tube while stirring for 1 hour to remove the oxygen. Then a gas mixture of 1% vol methylmercaptane in nitrogen was passed through the solution with 1Nl/h until no more methylmercaptane was absorbed (breakthrough after 170 min). The concentration of the gas components was determined by GC. Thereafter, the solution was stripped with nitrogen for 1 hour and then 1 gram of catalyst (Palladium on Coal) was added. The regeneration was started by passing air trough the solution (2-4Nl/h) for 6 hours after which the catalyst was removed from the solution by filtration using a 0.45 μm filter. Only a slight discoloration had occurred. Finally, the absorption procedure was repeated to test the effectiveness of the regeneration showing (almost) complete regeneration (breakthrough after 160 min). Without the regeneration procedure, breakthrough in a second run was almost instantaneous.

1. A process for removing mercaptans from a gas stream, comprising the steps:
(a) contacting a gas stream comprising at least a mercaptan of the general formula R₁—SH, wherein R₁ is an alkyl group comprising 1 to 4 carbon atoms, with an absorption medium comprising (1), (2) and (3):
(1) a solvent;
(2) a substituted disulfide of the general formula R₂—SS—R₃ wherein R₂ and R₃ are carbon comprising substituents of which the corresponding R₂—SH and R₃—SH thiols have a vapour pressure below the vapour pressure of any R₁—SH thiol and at least one of R₂ and R₃ is an electron withdrawing group; and
(3) at least a catalytic amount of a base, the catalytic amount being at least 3 mol % with regard to the amount of the substituted disulfide;
wherein the absorption medium is an aqueous solution comprising the substituted disulfide and the base;
(b) retrieving the absorption medium after use in step (a);
(c) regenerating the absorption medium in a regeneration unit;
(d) recycling the regenerated absorption solution to step (a);
wherein the process further comprises a step (c)′, which follows step (c) and precedes step (d), in which at least a part of the regenerated absorption medium is subjected to oxidation.

2. A process according to claim 1, wherein the substituted disulfide (2) is present in the absorption medium in 50 weight % or less.

3. A process according to claim 1, wherein the agent used for oxidation in step (c)′ is an oxidant which produces products that are already present in the solution.

4. A process according to claim 1, wherein the agent used for oxidation in step (c)′ is selected from H₂O₂, organic peroxides, iodine, amine-N-oxides, nitrogen oxides, sulphur, sulphur dioxide, (a gas containing free) oxygen.

5. A process according to claim 1, wherein the absorption medium is an amine-containing absorption medium.

6. A process according to claim 1, wherein at least one of R₂ and R₃ is an alkanol, alkoxy or aryl group.

7. A process according to claim 1, wherein the absorption medium in step (c) is regenerated by subjecting it to an elevated temperature, in particular to a temperature in the range of from 80 to 200° C.

8. A process according to claim 7, wherein the effluent from the regeneration unit having an elevated temperature is used in heat exchange contact with the absorption medium retrieved in step (b) to increase its temperature when it is being transferred to the regeneration unit.

9. A process according to claim 1, wherein step (c)′ is an on-line step.

10. A system for removing mercaptans from a gas stream, the mercaptan being of the general formula R₁—SH, wherein R₁ is an alkyl group comprising 1 to 4 carbon atoms, the system comprising
(p) a mercaptan removing unit which comprises an absorption medium comprising: (1) a solvent; (2) a substituted disulfide of the general formula R₂—SS—R₃ wherein R₂ and R₃ are carbon comprising substituents of which the corresponding R₂—SH and R₃—SH thiols have a vapour pressure below the vapour pressure of any R₁—SH thiol and at least one of R₂ and R₃ is an electron withdrawing group; and (3) at least a catalytic amount of a base, the catalytic amount being at least 3 mol % with regard to the amount of the substituted disulfide; wherein the absorption medium is an aqueous solution comprising the substituted disulfide and the nitrogen-containing base;
(q) a regeneration unit, in which the absorption medium after use in a mercaptan removing unit is regenerated; and
(r) an oxidation unit, positioned after the regeneration unit.
